(19) United States
(12) Patent Application Publication
(10) Pub. No.: US 2008/0007852 A1
(43) Pub. Date: Jan. 10, 2008

(54) Reflectance Control Optical Element and Ultrathin Film Light Absorption Enhancing Element

(75) Inventor: Mitsuo Kawasaki, Kyoto-shi (JP)

Correspondence Address: OLIFF & BERRIDGE, PLC, P.O. BOX 320850, ALEXANDRIA, VA, 22320-4850, US

(73) Assignee: Kyoto University, Kyoto-shi, KYOTO (JP)

(21) Appl. No.: 11/883,530

(22) PCT Filed: Feb. 7, 2006
(86) PCT No.: PCT/JP06/02029

§ 371 Date: Aug. 1, 2007

(30) Foreign Application Priority Data
Feb. 9, 2005 (JP) 2005-033358

(51) Int. Cl. G02B 5/26; B05D 3/06; G11B 7/24

(52) U.S. Cl. 359/884; 369/288; 427/554

(57) ABSTRACT

The present invention provides a simple-structured reflectance control optical element whose reflectance can be significantly changed and precisely controlled. A transparent film is provided on a substrate having a high reflectance, and further on the surface, an ultrathin film consisting of a metal thin film in which metal nanoparticles having an average particle diameter of 10 nm or less are adjacent to or in contact with each other. The metal is at least any of a single platinum group element, an alloy of platinum group elements, and an alloy of a platinum group element and nickel. The thus obtained element having a three-layer structure has a characteristic of a sharp drop in the reflectance to the light of a given wavelength. By appropriately selecting the thickness or the refractive index of the transparent film, the thickness or the materials of the ultrathin film, and the like, it is possible to control the reflectance according to wavelength. In particular, the metal thin film consisting of a platinum group element makes it feasible to easily control the presence or absence of the ultrathin film by pulsed laser irradiation. Moreover, the present invention provides a light absorption enhancing element in the ultrathin film taking advantage of the reflectance modulation characteristics.

### TECHNICAL FIELD

The present invention relates to an optical element capable of changing the reflectance or absorptivity of light according to the wavelength.

### BACKGROUND ART

Various kinds of optical storage media for storing or reproducing digital information, such as CDs and DVDs, are widely prevalent. Since the amount of information recently has been significantly increased as a result of the advancement of a variety of technologies, there is a demand for optical storage media that has a larger capacity for storing more information.

For the purpose of increasing the storage density of optical storage media, various relating techniques have been developed. For example, Patent Document 1 discloses a multilayer film structure obtained by laminating, via a transparent resin film layer in between, a plurality of island-like metal thin films having different spectral characteristics each consisting of fine metal powders of 100 nm or less in diameter, in which each of the island-like metal thin films serves as an optical storage layer, and the multilayer film structure is used as multiwavelength optical storage medium. Irradiation of a laser light having a high energy density near the resonance wavelength of the respective metal layers makes the metal powders absorb light and generate heat, causing local melting or deformation of the peripheral transparent resin media, and as a result of this the reflectance around the laser-irradiated portion is changed so that a mark is recorded.

In this kind of technique utilizing the reflection or transmittance of light, in order to reliably store or reproduce information, it is important that, when storing information, the reflectance or absorptivity of the media forming the recording layer be changed as much as possible. Regarding this technology, Patent Document 2 discloses a light transmissive material-ablation type, three-layered optical storage media including a light-reflecting material, a layer of light transmissive material on the light-reflecting material, and a layer of light-absorbing material on the light transmissive layer. According to this technique, by appropriately setting the thickness of the light transmissive layer or the thickness of the light absorbing material layer, it is possible to reduce the light reflectance of the light-absorbing material layer. On the other hand, by forming an opening by ablating the light-absorbing layer so as to expose the underlying light-reflecting layer, it is possible to perform optical storage utilizing a difference between the high reflectance of the light-absorbing layer and the low reflectance of the light-absorbing material layer.

Patent Document 3 discloses a technique for modifying the three-layered optical storage media disclosed in Patent Document 2, where the outermost layer consists of a so-called “island film” having a configuration in which metal particles having a particle diameter of approximately 10-30 nm are independently present with an interval of about 5-20 nm in between. In Patent Document 3, gold, which has an excellent stability especially in air, is used as the metal particles. According to this technique, irradiation of laser light to the island film causes thermal aggregation of the peripheral portions of the irradiated part in a convex shape, increasing void spaces, and as a result, the light absorptivity of the above-mentioned section is reduced so that it is possible to perform optical storage by utilizing the optical change.

[Patent Document 1] Japanese Unexamined Patent Application Publication No. 2002-11957

[Patent Document 2] U.S. Pat. No. 4,329,697

[Patent Document 3] International Publication Pamphlet WO83/04332

### DISCLOSURE OF THE INVENTION

### Problems to be Solved by the Invention

The island films using gold, disclosed in Patent document 3, have a problem that, when the particles forming the island films are agglomerated and granulated by irradiation of a laser beam, the granulated particles have a strong Plasmon absorption in the visible region, limiting the wavelength at which light absorptivity is reduced, as well as increasing light absorption at some wavelengths. Further, there is a problem with the island films composed of gold that, despite their high stability against oxidation, they do not have enough stability for use as an optical element, because its light absorption characteristics can often change with a lapse of time.

On the other hand, an optical element having a laminated structure capable of significantly modulating the reflectance has been known as disclosed in Patent Document 2 and Patent Document 3. However, what is known is only a basic structure, and such a structure is far from being optimal for sufficiently taking advantage of the optical characteristics of the optical element.

### Means for Solving the Problems

To solve the above-mentioned problems, the present invention provides a reflectance control optical element capable of causing a change in the reflectance of light according to the wavelength, including:

a substrate including a material having a high reflectance;

a transparent film including a material having a light transmissivity formed on the surface of the substrate; and

an ultrathin film including a material with a predetermined light absorptivity formed on the surface of the transparent film, where:

the aforementioned ultrathin film is a metal thin film, which is made of metal nanoparticles having an average particle diameter of 10 nm or less, the metal nanoparticles being adjacent to or in contact with each other, and
the metal is at least one member selected from the group consisting of a single platinum group element, an alloy of platinum group elements, and an alloy of a platinum group element and nickel.

As another mode of the reflectance control optical element, the present invention provides a light absorption enhancing element in an ultrathin film, which is characterized by the surface of the substrate being formed with a light scattering reflection film in the previously described reflectance control optical element.

In the present specification, “light” includes not only visible light but also any electromagnetic wave.

### EFFECT OF THE INVENTION

The reflectance control optical element of the present invention can cause a change in reflectance according to wavelength, and thus it is possible to dramatically improve the credibility of an optical storage medium, which stores and reproduces digital information by the reflectance change. Moreover, since it is possible to freely control the wavelength at which the reflectance peaks and the wavelength at which the reflectance is minimized by properly setting the materials and the thickness of the transparent film and ultrathin film, the reflectance control optical element of the present invention can be applied to a broad range of fields. Furthermore, since the ultrathin film has a metal thin film structure in which platinum group metal nanoparticles having an average particle diameter of 10 nm or less are in a state adjacent to or in contact with each other, it is possible to accurately control the materialistic existence or non-existence of the ultrathin film by pulsed laser irradiation. Therefore, in using the reflectance control optical element of the present invention as an optical storage medium or the like, high density storage can be achieved by taking advantage of the high resolution.

In addition, the basic structure of the element is a simple structure consisting of three layers, which is advantageous in that the production cost is minimal.

In the light absorption enhancing element, which is another embodiment of the light reflectance control element of the present invention, the light absorbing effect of the ultrathin film can be enhanced ten times or more with a very simple structure. Therefore, it is possible to form an ultrathin film which is very thin and yet also has an excellent light absorption capability.

### BRIEF DESCRIPTION OF THE DRAWINGS

FIG. 1 shows a schematic structural diagram of a reflectance control optical element according to the present invention.

FIG. 2 shows an AFM (atomic force microscope) image of a Pt ultrathin film produced by DC (direct current) sputtering method.

FIG. 3 shows an AFM image of the Pt ultrathin film of FIG. 2 after pulsed laser irradiation.

FIG. 4 shows absorption spectrums of the Pt ultrathin film before and after pulsed laser irradiation.

FIG. 5 is a graph showing the reflectance of a reflectance control optical element according to the present invention.

FIG. 6 is a graph showing the reflectance when a transparent film having a thickness of 0.5 μm is used.

FIG. 7 is a graph showing the reflectance when a transparent film having a thickness of 90 nm is used.

FIG. 8 is a graph showing the reflectance when the refractive index of the transparent film and the thickness of the transparent film are changed.

FIG. 9 is a graph showing the relationship between the thickness and the reflectance of the ultrathin film.

FIG. 10 is a graph showing the reflectance when a dye is used in an ultrathin film in the element according to the present invention.

FIG. 11 is a graph showing the reflectance when the ultrathin film is formed by laminating three different kinds of dyes.

FIG. 12 shows a schematic structural diagram of a light absorption enhancing element in the ultrathin film according to the present invention (upper side), and an explanatory diagram showing an onset of the light absorption enhancing effect (lower side).

FIG. 13 is a drawing showing another structure of the light absorption enhancing element in the ultrathin film according to the present invention.

FIG. 14 shows a structural diagram of an element used in the comparative examples in an experiment for investigating the enhancing effect of the light absorption enhancing element in the ultrathin film.

FIG. 15 is a graph showing the relationship between the excitation light wavelength and fluorescence intensity of each element used in the comparative examples.

FIG. 16 is a graph showing the relationship between fluorescence intensities and a thickness of the transparent film.

FIG. 17 is a graph showing measurement results of the surface roughness of Ag-SS, which is a sample of light scattering reflection film (upper side), and a graph showing measurement results of the surface roughness of the SOG (spin-on glass) surface (lower side).

FIG. 18 is a graph showing measurement results of the surface roughness of AG-S, which is a sample of light scattering reflection film (upper side), and a graph showing measurement results of the surface roughness of the SOG surface (lower side).

FIG. 19 shows a specular reflection spectrum (left) of the sample of Ag-SS, and a scattering spectrum (right) of the sample of Ag-SS.

FIG. 20 shows a specular reflection spectrum (left) of the sample of Ag-S, and a scattering spectrum (right) of the sample of Ag-S.

FIG. 21 is a graph showing relationship between the wavelength and the fluorescence intensity of each of the light absorption enhancing element and the element of the comparative example in the ultrathin film.

FIG. 22 shows a structural diagram of the element in the case where the reflectance is changed by changing the thickness of the transparent film, and a table showing a relationship between the thickness and the reflectance of the transparent film.

FIG. 23 shows a scanning electron microscope image of an interference pattern produced by pulsed laser irradiation on a Pt ultrathin film (thickness: 5 nm).

FIG. 24 shows a scanning electron microscope image of an interference pattern produced by pulsed laser irradiation on a Pt ultrathin film (thickness: 20 nm).

FIG. 25 is a graph showing the first-order diffraction efficiency of diffraction gratings produced by using the element according to the present invention.

### EXPLANATION OF NUMERALS

1 . . . Substrate
2 . . . Transparent Film
3 . . . Ultrathin Film

### BEST MODE FOR CARRYING OUT THE INVENTION

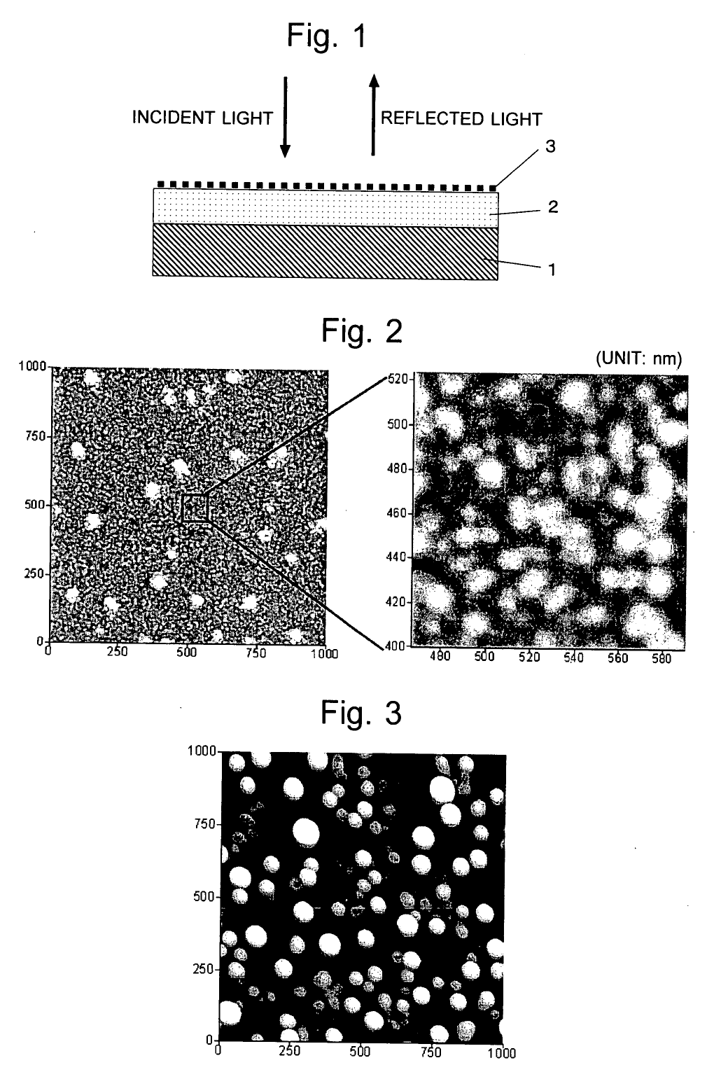

A schematic diagram of the reflectance control optical element of the present invention is shown in FIG. 1. The reflectance control optical element of the present invention is essentially composed of three layers of a substrate 1, a transparent film 2, and an ultrathin film 3. The following describes materials forming each of the layers.

Materials forming the substrate are not particularly limited; however, in consideration of achieving a large reflectance difference, it is of course desirable that the materials should be those having as high a reflectance level as possible. Examples of such materials include metals such as aluminum, gold, and silver. Moreover, in the present invention, the thickness of the substrate is not limited; it may be a thin film or bulk.

Materials forming the transparent film may be any, including any kinds of glass and polymer, as long as the material has light transmissivity. However, with the objective of achieving high reflectance, the material is desirably as transparent as possible (i.e. its light absorptivity should be low.) Also, a transparent electrode such as ITO (Indium Tin Oxide) may be used as a transparent film when utilizing the light absorption enhancing effect of the reflectance control optical element of the present invention.

As will be described later, the wavelength-dependent reflectance of the reflectance control optical element of the present invention changes depending on the thickness and the refractive index of the transparent film.

The ultrathin film is formed on the surface of the aforementioned transparent film, and the thickness thereof is normally several tens of nm or less. According to the optical element of the present invention, incident light is scarcely absorbed in any of the substrate and the transparent film. Therefore, it is presumed that the presence of the ultrathin film should mainly cause a large change in reflectance. Materials forming the ultrathin film are not particularly limited; however, the materials desirably have high light absorption (i.e. its light absorptivity should be higher than reflectance in the case of the preferable thickness according to the present invention described later) in order to cause a large change in reflectance.

The ultrathin film is desirably a metal thin film composed of metal nanoparticles, in which each particle is densely located adjacent to or in contact with each other, and a single layer or several layers of the metal thin film are formed in a thickness direction and distributed almost evenly in a plane direction. In this metal thin film, an average particle diameter of the metal nanoparticles is desirably in the range of 3 to 10 nm. It is possible to produce a metal thin film having a structure of this kind by, for example, DC sputtering method. FIG. 2 shows an AFM image of a platinum (Pt) ultrathin film produced by DC sputtering method. The thickness of the film is approximately 5 nm.

The aforementioned metal thin film is optically equivalent to a complete continuous film, and thus it can be simulated using optical constants of a bulk, which is advantageous for designing the element. On the other hand, since the metal thin film is thermally and electrically discontinuous, thermal diffusion along the film rarely occurs, and the electrical conductivity is low.

The ultrathin film having the aforementioned characteristics is advantageous when the element of the present invention is utilized as optical storage medium. For example, suppose that a laser is irradiated to predetermined areas of the ultrathin film. The metal nanoparticles existing in those areas absorb energy of the irradiated light, and generate heat and then dissolve, and then a plurality of the metal nanoparticles coalesce with one another so that they are agglomerated and granulated. Since the agglomerated and granulated areas do not absorb light for the reasons described later, it is possible to form areas where practically no ultrathin film is present. Above all, due to the characteristic of rare thermal diffusion occurrence, energy is concentrated only at areas where laser has been irradiated in the ultrathin film. Accordingly, it is possible to accurately control the materialistic existence of the ultrathin film, and therefore high density storage with an excellent resolution can be realized. Herein, for further improving the resolution, a pulsed laser is preferably used at the time of laser irradiation so as to reduce the thermal diffusion to a minimum level.

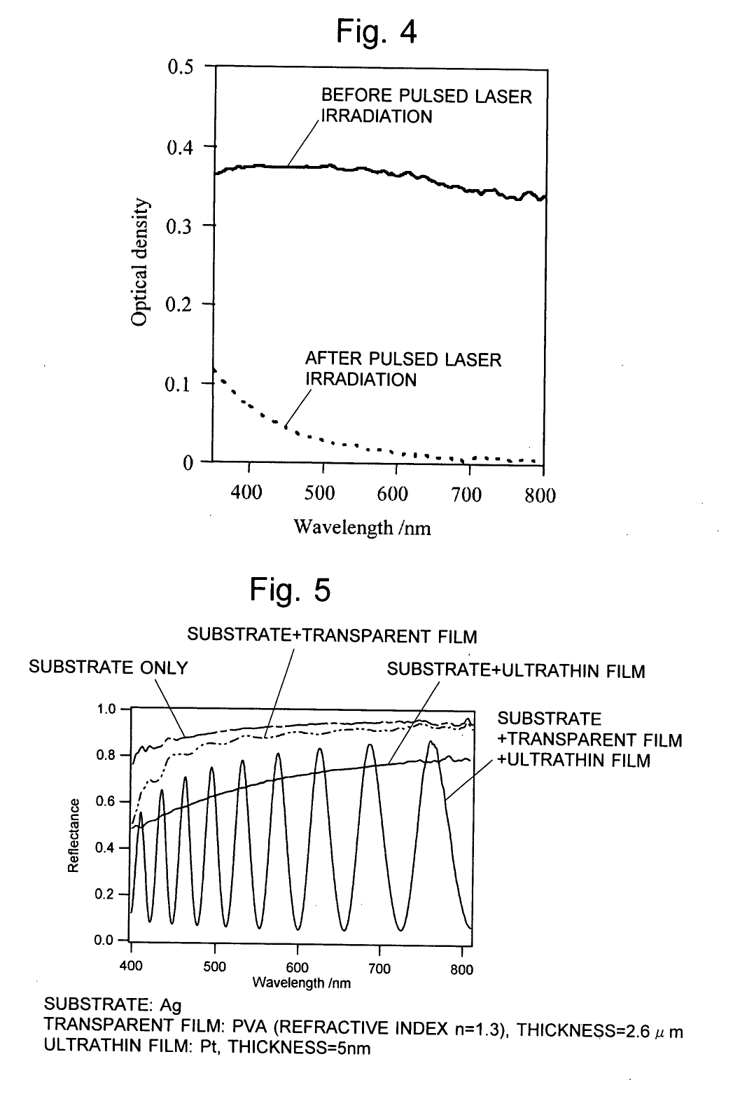

The present inventor has found that platinum group elements such as platinum and palladium are particularly preferable as the metal capable of relatively easily realizing the aforementioned ultrathin film. Platinum group elements have a thermal conductivity as low as approximately one fifth of gold, silver, copper or the like, and are also excellent in chemical stability and thermal stability. In the cases of gold, silver, copper or the like, upon producing the ultrathin film, individual particles tend to have a large particle size, making it difficult to obtain the metal nanoparticles having a particle diameter of 10 nm or less. Furthermore, since independent spherical nanoparticles of platinum have almost no absorptivity in the visible region, when they are irradiated by a laser and thus agglomerated and granulated while being used as the materials for the ultrathin film (absorption in the visible region is caused by adjacence or contact of the nanoparticles), the granulated part becomes transparent in the visible region. FIG. 3 shows an AFM image of the Pt ultrathin film of FIG. 2 after pulsed laser irradiation. The image shows that platinum, which was previously spread like a film, is agglomerated and granulated in the spherical shape. As shown by this image, several tens of percent of the entire surface are covered with the agglomerated particles even after laser irradiation (FIG. 3). However, as indicated by the graph in FIG. 4 showing the change of the absorption spectrum before and after pulsed laser irradiation, the agglomerated particles have almost no light absorptivity in the visible region.

In the element of the present invention, the platinum metal group element may be a simple substance or an alloy. Further, for the purpose of increasing the mechanical strength of the ultrathin film or its adhesive strength to the transparent film, it is possible to use an alloy with a hard material such as nickel, as materials forming the ultrathin film.

The following description will discuss the detailed structure of the reflectance control optical element and the ultrathin film light absorption enhancing element of the present invention.

<Thickness of Transparent Film>

The wavelength-dependent reflectance of the reflectance control optical element of the present invention changes depending on the thickness of the transparent film 2. FIG. 5 is a graph showing the reflectance of the element when silver is used for the substrate, PVA (poly vinyl alcohol) is used for the transparent film, platinum is used for the ultrathin film, the thickness of the transparent film is 2.6 μm, and the thickness of the ultrathin film is 5 nm. As compared with the case where the element is composed only of the substrate, composed of the substrate and the transparent film, or composed of the substrate and the ultrathin film, the reflectance is significantly changed only in the case where the element is composed of the three layers of the substrate, the transparent film and the ultrathin film, and has a maximum value and a minimum value depending on the wavelength of the incident light.

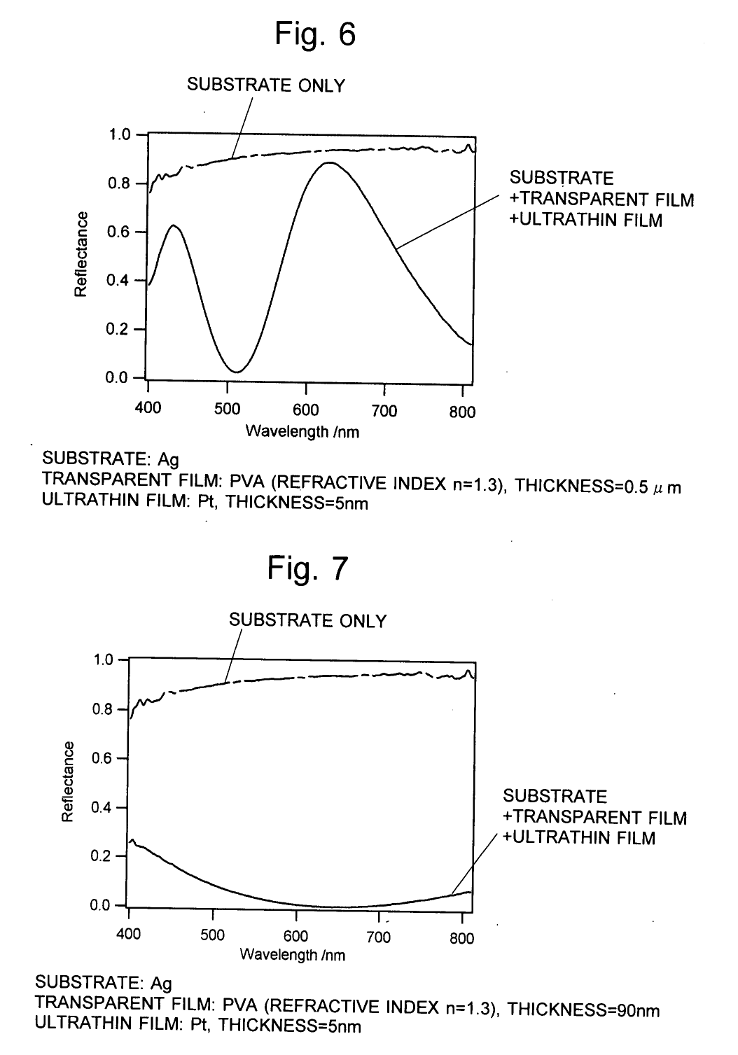

A graph of the reflectance obtained when the thickness of the transparent film was set to 0.5 μm in the aforementioned condition is shown in FIG. 6. Also, a graph of the reflectance obtained when the thickness of the transparent film was set to 90 nm is shown in FIG. 7. It has been confirmed that a lesser thickness of the transparent film results in a larger cycle of the maximum and minimum values of the reflectance. Furthermore, this result very well corresponds to the result of the simulation performed by the present inventor. In other words, by properly setting the thickness of the transparent film, it is possible to design a reflectance control optical element whose reflectance sharply drops at a desired wavelength.

<Refractive Index of Transparent Film>

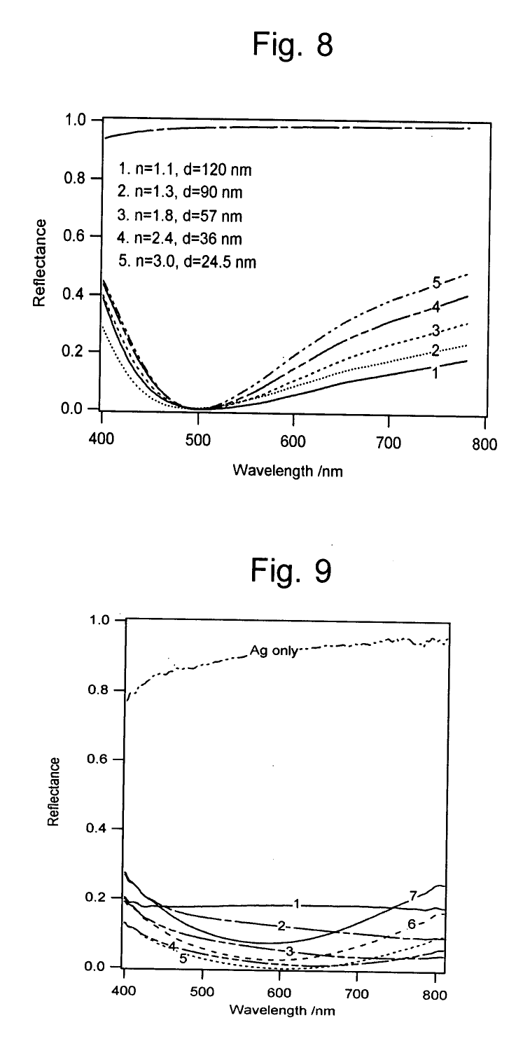

A simulation was performed to examine the influence of the refractive index of the transparent film on the wavelength-dependent reflectance change. Silver is used as the substrate, and an ultrathin film of platinum having a thickness of 5 nm was used, and the refractive index and the thickness of the transparent film were changed to lower the refractive index over the entire visible region. FIG. 8 is a graph showing the reflectance in this case. It is shown that the change of the reflectance depending on the wavelength of the incident light can be controlled by decreasing the thickness of the transparent film along with the increase of the reflective index of the transparent film. Moreover, it is confirmed that a transparent film with a relatively small refractive index is preferably used in order to decrease the reflectance as much as possible over the widest possible wavelength range.

<Thickness of Ultrathin Film>

Next, an experiment was performed to examine how the thickness of the ultrathin film affected the reduction of the reflectance. A substrate composed of silver and a transparent film composed of spin-on glass (refractive index n≈1.3 to 1.5) having a thickness of 80 nm were used, and the thickness of an ultrathin film (platinum) was changed in a range of 3 to 10 nm. The results are shown in FIG. 9. In FIG. 9, the thickness of the ultrathin film decreases in the order of Nos. 1 to 7. This result confirms that presence of an ultrathin film having a thickness of several nanometers causes a significant reduction in the reflectance. Further, additionally taking into consideration the simulation results that are not shown, it is confirmed that the reflectance entirely shows a tendency of increase in the cases where the ultrathin film is too thick or too thin. Also, it is confirmed that the reflectance is at the minimum level when the thickness is approximately in the range of several nanometers to several tens of nanometers. When a most preferable thickness of the ultrathin film for allowing the reflectance at a certain wavelength to be the lowest value is generally expressed by a light transmissivity in the thickness direction, it has been confirmed that the thickness is preferably designed in such a manner that the light transmissivity of the ultrathin film at a given wavelength falls within the range of 30 to 60%.

<Dye Ultrathin Film>

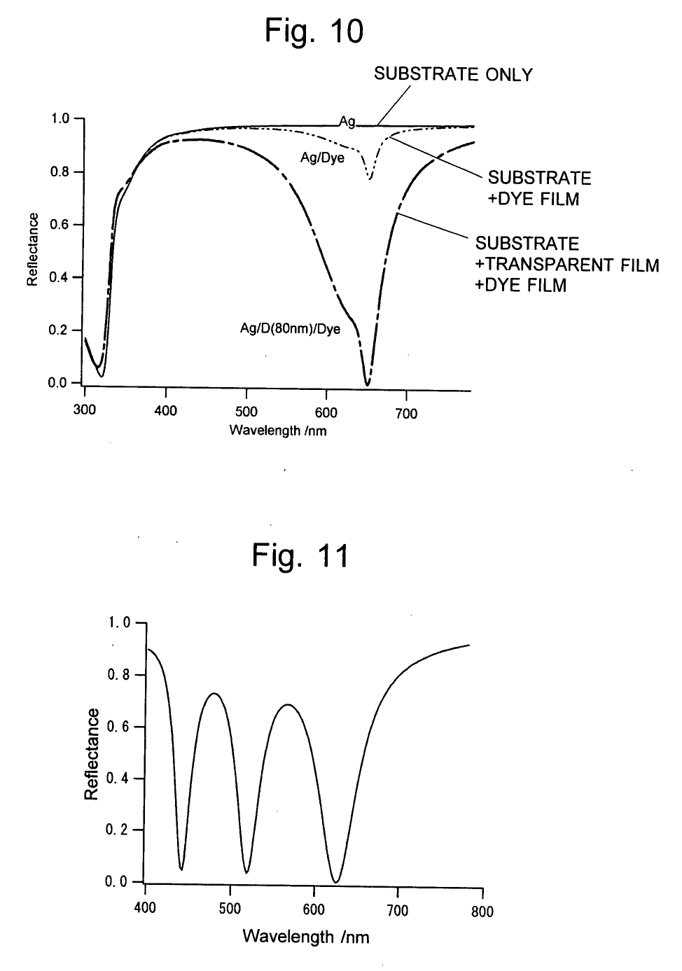

A dye can be used as a material for the ultrathin film, instead of metal nanoparticles. In the present invention, the dye is not limited to those which are generally called a dye, but refers to any material having a property of absorbing light of a specific wavelength spectrum. A composite material containing a dye as a main component is also included. The dye alone does not noticeably change the absorptivity of light, even if the thickness of a dye film is increased. On the other hand, when a dye is used in the ultrathin film of the element of the present invention, it becomes possible to significantly increase its light absorptivity. FIG. 10 is a graph showing the simulation results of the reflectance of an element consisting of a substrate (silver), a transparent film (reflectance: n=1.3, thickness: 80 nm), and a dye ultrathin film (thickness: 10 nm). The graph shows that the presence of the transparent film significantly reduces the reflectance from the reflectance observed in the case where the element consists only of the substrate and the dye ultrathin film. Moreover, also in the case of using a dye in this manner in the ultrathin film, it is possible to control the change of the reflectance by properly selecting the thickness and the like of the transparent film in the aforementioned manner.

It is also possible to form the ultrathin film using a plurality of dyes having different light absorption characteristics. In this case, the dyes may be mixed, or the ultrathin film may be formed by laminating layers of each dye. In consideration of the application as a multiple recording layer, the layer structure, like the latter, in which each dye layer functions independently is desirable. Supposing that the thickness of one dye layer is approximately 10 nm, even the lamination of three layers results in a thickness of only approximately several tens of nanometers, and thus causes no problem for the transparency of the ultrathin film. As one example of this, the graph in FIG. 11 shows the simulation results of the reflectance of an element consisting of a substrate (silver), a transparent film (reflectance n=1.3, thickness 80 nm), and an ultrathin film consisting of layers of three different kinds of dyes each having a thickness of 10 nm, laminated on the surface of the transparent film. FIG. 11 indicates that the aforementioned element has reflectance characteristics in which reductions of reflectance at the light absorption wavelength specific to each of the dyes are overlapped. By utilizing this technique, wavelength-multiplexed recording can be easily performed by properly selecting a dye system.

[Ultrathin Film Light Absorption Enhancing Element]

As described above, the reflectance control optical element of the present invention can extremely reduce the reflectance by the appropriate design of its structure. That is to say, it is definitely possible to significantly increase the light absorptivity in the ultrathin film.

Meanwhile, many of the optical function devices such as an optical sensor and a photoelectric transducer have a laminated structure including a photoexcitation layer (light absorption layer). The energy transfer or the material transfer due to the crossing of nonequilibrium energy generated in the light absorption layer or charge carriers (electron or hole) across layer boundaries have a very important role, and therefore the thickness of the light absorption layer is desirably as small as possible. Otherwise, those carriers will be deactivated inside the light absorption layer, and the desired function will not be initiated. There are quite a few devices in which the thickness of the light absorption layer is set to the monomolecular layer level. A typical example of this kind of device in which the light absorption layer is thinly formed includes a dye-sensitized solar cell utilizing the light absorption of a dye adsorbed on the titanium oxide surface. However, the light capturing (absorption) efficiency of a dye layer of a monomolecular level decreases from a high level to approximately several to 10 percent due to the small level of thickness. As a technique for compensating this situation, some techniques are applied. For example, in the dye-sensitized solar cell, titanium oxide is formed into an aggregate of nanoparticles or a porous body so as to obtain a larger effective surface area for dye absorption. This technique, however, cannot always be extensively used in general applications, and the system is naturally complicated. In addition, the technique is expensive.

On the other hand, if the light absorptivity of a thin layer of a monomolecular layer level can be enhanced by more than ten times, the light capturing efficiency of approximately 100% should be obtained, and as a result, it becomes possible to realize an optical functional device with much more simple element structure as compared with the conventional ones.

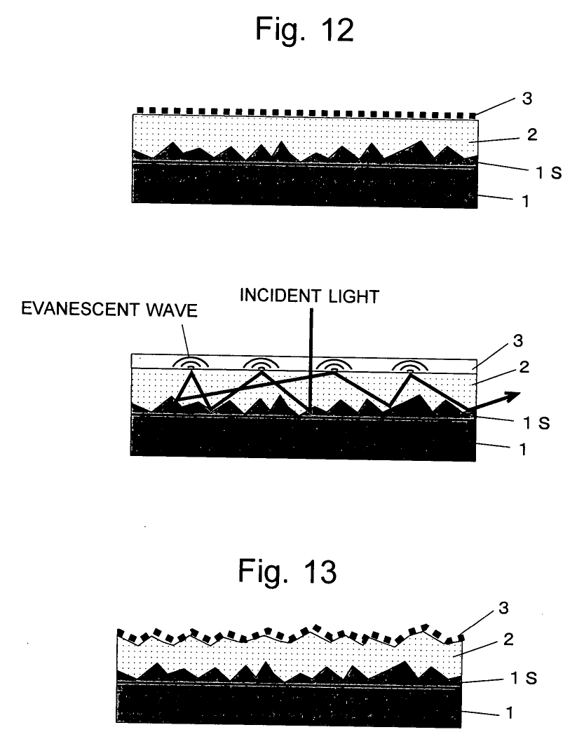

As a structure capable of dramatically enhancing the absorption efficiency of the ultrathin film, by which the aforementioned problems can be solved, the present inventor thought of the structure of the reflectance control optical element of the present invention, in which the surface of the substrate is formed into a light scattering reflection film. That is, as shown in FIG. 12 for example, the structure includes a substrate 1, a light scattering reflection film 1S provided on the surface of a substrate 1, a transparent film 2 formed on the light scattering reflection film 1S and provided thereon an ultrathin film 3. In this structure, a dye is preferably used for the ultrathin film with the objective of the enhancement of the light absorption capacity. It is of course possible to use a platinum group metal used in the aforementioned reflectance control optical element. Hereinafter, the “ultrathin film” will be arbitrarily referred to as “absorption film.”

With this structure, as shown on the lower side of FIG. 12, an incident light is reflected at the light scattering reflection film 1S, and most of the light is totally and internally reflected at the lower surface of the ultrathin film (absorption layer). At this stage, an evanescent wave is generated in the absorption film. The evanescent wave has a stronger interaction with the materials forming the absorption layer as compared with normal light, and consequently the absorptivity of the absorption layer is significantly increased. On the other hand, the scattering reflection on the light scattering reflection film 1S and the total internal reflection on the absorption layer have an effect of trapping the light inside the transparent film 2, and thus absorption is more efficiently enhanced. Moreover, normal absorption enhancement of approximately several times achieved in a three layer structure including a transparent film of approximately 100 nm thickness is still maintained in a system where light scattering occurs as mentioned above. The enhancing effect integrating those effects is so significant that even an ultrathin film usually having only approximately several percent of light absorptivity can increase the light absorptivity by ten times or more when having this structure.

In this structure, an optimal roughness of the light scattering reflection film 1S depends on the thickness of the transparent film. As mentioned above, for reducing the reflectance as much as possible, or in other words for achieving a high absorption, in the reflectance control optical element of the present invention, the refractive index of the transparent film 2 is desirably as low as possible, and for such refractive index the optimal thickness of the transparent film 2 is approximately 100 nm (description below). This indicates that the upper limit of the roughness of the light scattering reflection film 1S is approximately 100 nm in terms of a ten point height of irregularities (Rz) value. More preferably, the roughness of the light scattering reflection film 1S is set to approximately 20% of the thickness of the transparent film 2. Moreover, for efficient light scattering, in the light scattering reflection film 1S, a cycle of a high-low formation is desirably almost equal to the wavelength of the incident light. A reflective film having such roughness can be produced in a relatively simple manner by, for example, DC sputtering method.

Further, in order to generate light scattering more efficiently inside the transparent film 2 to increase the absorptivity, it is preferable that the surface of the transparent film 2 should have approximately the same roughness as that of the light scattering reflective substrate as shown in FIG. 13. By forming the transparent film using a spin-on glass (hereinafter abbreviated as SOG), it is possible to obtain the transparent film 2 naturally having the preferable roughness as mentioned above.

The following describes the experiment performed by the present inventor for confirming the light absorption enhancing effect of the reflectance control optical element having the aforementioned structure. In this example, as the ultrathin film (absorption layer), a fluorescent organic dye was used and was thinly formed with a thickness of approximately several nanometers. In this case, the light absorptivity of the ultrathin film itself is only less than several percent.

Specifically, rhodamine B (RhB), which is a fluorescent organic dye, was dissolved in a 0.1% polyvinyl alcoholic solution at a concentration of 0.05 mM, and the solution was spin coated on the transparent film at 3000 rpm. The resulting ultrathin film had a thickness of approximately 3 nm, and the amount of supported RhB dye contained therein, as the molecular number per unit projected area, was 1.3-2.0×10¹³/cm². The support amount fell within the above-mentioned range in both cases where the surface of the transparent film was smooth and rough. The light absorptivity of the ultrathin film itself was approximately 1% at a maximum absorption wavelength. In the experiment, in order to confirm the absorptivity enhancing effect, the fluorescence intensity upon photoexcitation under the same condition was measured, instead of directly measuring the absorptivity.

### COMPARATIVE EXAMPLES

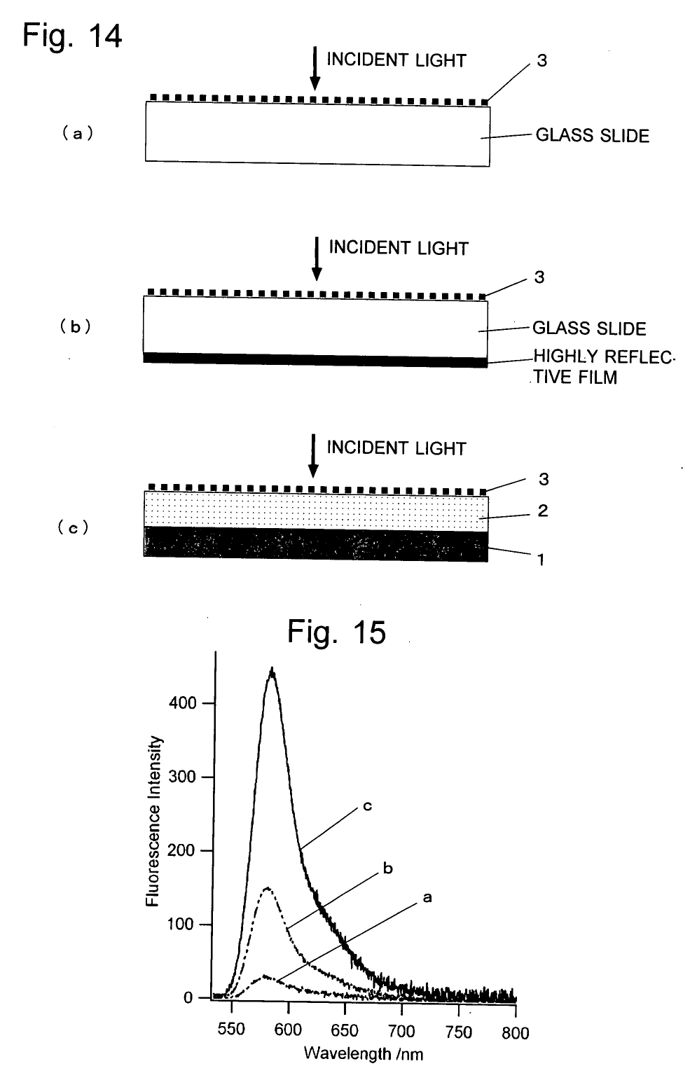

Samples with the following structures (a) to (c) (FIG. 14) were prepared.
(a) Substrate: none, transparent film: glass slide (thickness: almost 1 mm), ultrathin film: RhB
(b) Substrate: highly reflective film (Ag), transparent film: glass slide, ultrathin film: RhB
(c) Substrate: highly reflective film (Ag), transparent film: SOG (thickness: approximately 100 nm), ultrathin film: RhB

Excitation light was made incident on each of the above-mentioned samples (a) to (c) in a direction perpendicular to the substrate, and the fluorescence was measured at approximately 40 degrees from the perpendicular on the ultrathin film side. The measurement results are shown in FIG. 15.

With the installation of the reflective film, the fluorescence intensity was enhanced by four times (a→b). The results correspond to the expectation that the fluorescence directed toward the reflective film, among the fluorescence generated in the ultrathin film, is reflected on the reflective film, and also the incident light passing through the ultrathin film without being absorbed therein is reflected on the reflective film and absorbed in the ultrathin film, which leads to approximately four times the enhancement.

Furthermore, when the transparent film was formed into an ultrathin film having a thickness of approximately 100 nm, the fluorescence intensity was enhanced by approximately three times (b→c). This result demonstrates that the basic structure of the reflectance control optical element of the present invention is effective for enhancing the absorptivity as well as controlling the reflectance.

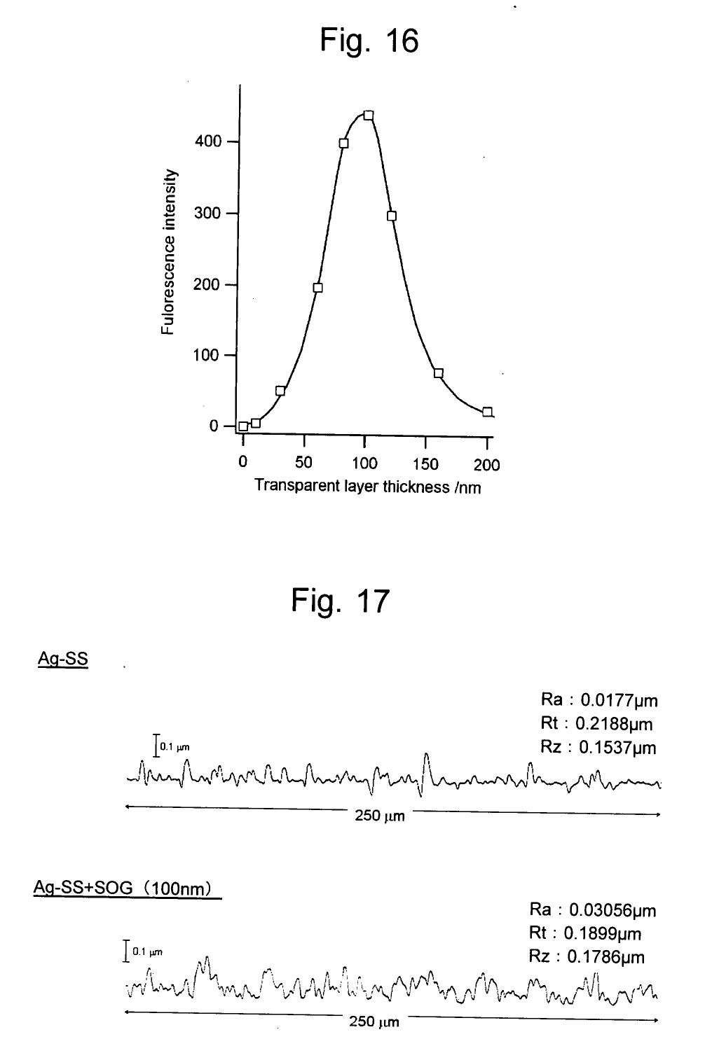

Herein, the present inventor examined the relationship between the fluorescence intensity and the thickness of the transparent film (material: SOG, refractive index: up to 1.4). As shown in FIG. 16, the fluorescence intensity peaked when the thickness of the transparent film was approximately 100 nm, and the fluorescence intensity decreased from the maximum value at any other thickness, regardless of whether the thickness was larger or smaller than 100 nm.

### TEST EXAMPLES

Next, a sample with the structure mentioned below was prepared as the ultrathin film absorption enhancing element of the present invention, and the fluorescence was measured in the same manner as the comparative example.
(d) Substrate: light scattering reflection film substrate, transparent film: SOG (thickness: 25 approximately 100 nm), ultrathin film: RhB

The light scattering reflection film was produced by DC sputtering under the condition that a silver thin film being deposited on a glass substrate was strongly exposed to plasma irradiation. The substrate was naturally heated to a temperature range from 50 to 100 degrees Celsius by plasma irradiation during the film formation, even without intentional heating. An excessive heating at this stage may cause excessive surface roughness, and thus precaution is required.

<Influence of Surface Roughness of Substrate>

The following description will discuss the characteristics of two kinds of light scattering reflection films having a roughness significantly different from one another.

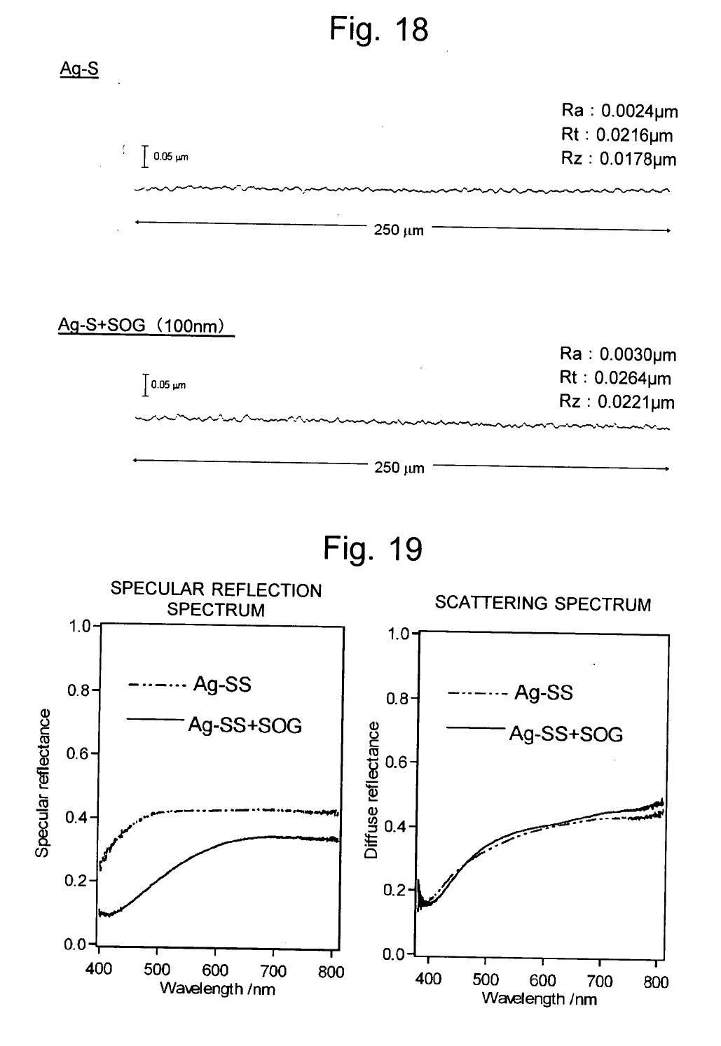

Hereinafter, the sample with a higher roughness is referred to as Ag-SS, and the sample with a lower roughness is referred to as Ag-S. FIG. 17 shows the results of measurement of the surface roughness of the Ag-SS light scattering reflection film and the surface roughness of a surface of SOG film (transparent film) having a thickness of 100 nm, using a probe type surface roughness meter. Further, FIG. 18 shows the results of the same measurement relating to the Ag-S.

The aforementioned roughness measurement results demonstrate that:
In the sample of Ag-SS, the difference of elevation of the light scattering reflection film is approximately equal to the thickness of the transparent film,
In the sample of Ag-S, the difference of elevation of the light scattering reflection film is approximately 20% of the thickness of the transparent film, and
In any of the Ag-SS and the Ag-S, the surface roughness of the transparent film is not so different from the surface roughness of the light scattering reflection film, and rather a tendency of increase is observed.

FIG. 19 and FIG. 20 show a specular reflection spectrum (left) and a scattering spectrum (right) of the Ag-SS and the Ag-S with or without the presence of the transparent film. It can be understood from those graphs that the presence of the transparent film causes significant changes of the reflection characteristics. In the Ag-SS (FIG. 19), the specular reflectance was reduced by 10 to 30% due to the presence of the transparent film, whereas almost no change was observed in the scatter reflectance. This indicates that the portion of light corresponding to the reduction of the specular reflectance is trapped inside the transparent film.

As for the Ag-S (FIG. 20) without the transparent film, the specular reflectance reached close to 80% in the long wavelength region, suggesting a small roughness and thus small scattering. On the other hand, in the case where the transparent film is present, the specular reflectance was significantly decreased as compared with the case of Ag-SS. This is evidence of the stronger trapping of light.

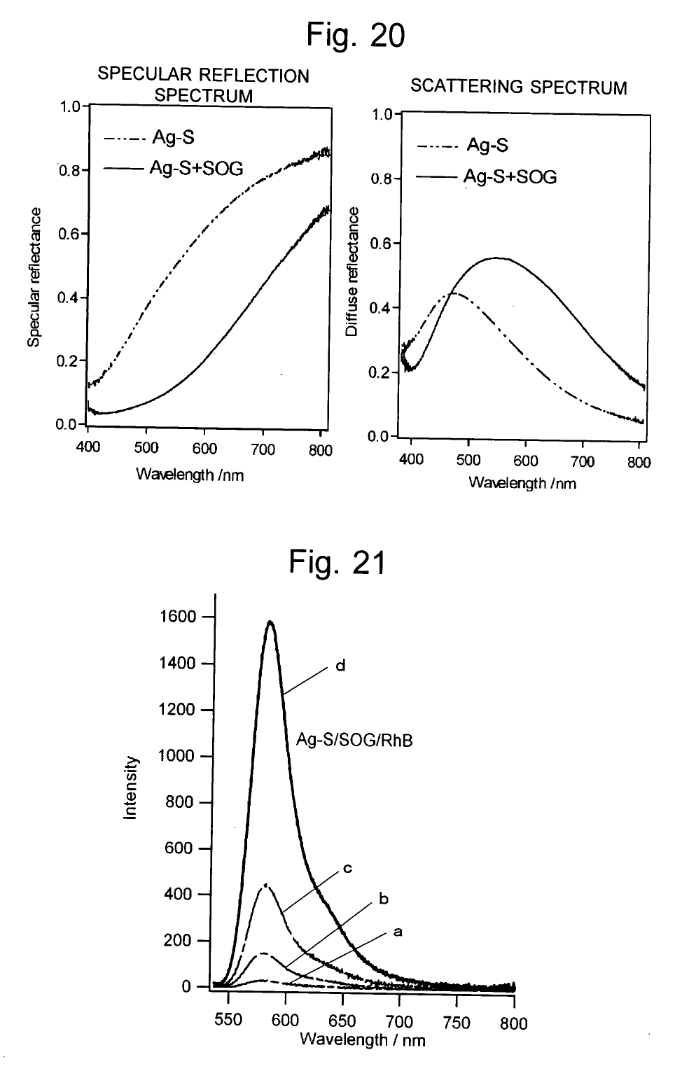

From the foregoing description, it can be said that the Ag-S has a higher fluorescence intensity than the AG-SS. FIG. 21 shows fluorescence intensity of the sample (d) (Ag-S), as well as fluorescence intensity of the samples (a) to (c). It is observed that the fluorescence intensity was enhanced by approximately four times as compared with the fluorescence intensity obtained in the reflectance control optical element having the basic structure (sample (c)) according to the present invention. This enhancing effect is more than ten times that of the structure in which an ultrathin film is simply provided on the glass surface (sample (a)).

In addition, as expected, the fluorescence intensity of the Ag-SS was up to approximately 700 at a maximum, showing a lower enhancing effect than the Ag-S.

### INDUSTRIAL APPLICABILITY

The reflectance control optical element of the present invention is directly applicable to high density ROM storage, because the reflectance can be significantly changed by the presence or absence of the ultrathin film. Further, large changes of the reflectance indicate that intensity of the reproducing light can be lowered. Moreover, the reflectance does not change so much even in the case where the angle of the incident light leans approximately up to 40 degrees. In other words, even though the storage medium slightly leans relative to the incident light, there is almost no influence on the reflectance, and accordingly it is possible to considerably simplify a media inclination control mechanism in a reproducing apparatus.

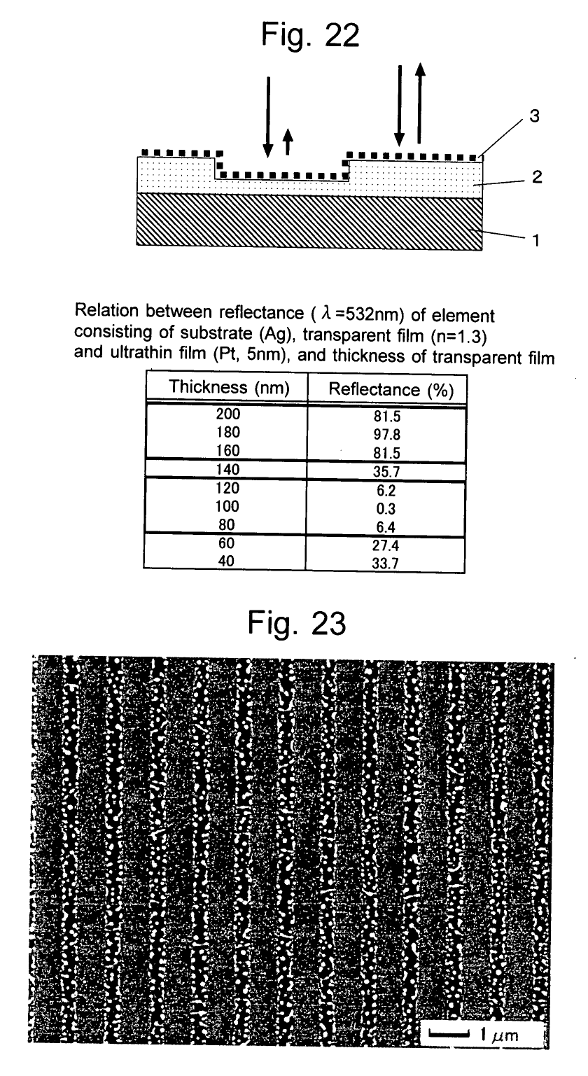

It is also possible to produce digital data media by making use of not the presence or absence of the ultrathin film, but the reflectance changes associated with the changes of the transparent film thickness. For example, as shown in FIG. 22, when an irregularity (pit) is properly formed on the transparent film of the reflectance control optical element of the present invention, the reflectance largely changes between a concave portion and a convex portion, making it possible to read out digital data utilizing the difference of the reflectance. For example, in the case of incoming laser beam of the wavelength of 532 nm, as shown in the lower table of FIG. 22, a thickness of the transparent film in the range of 180±20 nm results in 80% reflectance, and a thickness of the transparent film in the range of 100±20 nm results in 10% or less reflectance. This result indicates that even the formation of the irregularity with a low accuracy error of approximately±20 nm is sufficiently practical. In addition, the thickness of the ultrathin film does not need to be very accurate; it can take any value within a range from 5 to 10 nm. It is of course possible to adjust the thickness and the like of the ultrathin film properly depending on the wavelength of the incident light.

The element which causes a large change in the reflectivity in a relatively narrow band of wavelengths (e.g. the element shown in FIG. 5) is usable as a reflective multi-band-pass optical filter having little energy loss. Moreover, depending on the needs, the element may be used together with another optical filter.

Furthermore, with the use of the reflectance control optical element of the present invention, it is possible to obtain a well defined interference pattern with excellent resolution, and accordingly a holographic storage media suitable for multiplexed digital hologram can be obtained.

Above all, in order to obtain an interference pattern with excellent resolution, the ultrathin film of the reflectance control optical element of the present invention should have a thickness of 20 nm or less, or desirably 10 nm or less. FIG. 23 shows a scanning electron microscope image of an interference pattern that was produced by interference of two pulsed laser beams on locations where a Pt ultrathin film having a thickness of approximately 5 nm is present. Observation shows a stripe pattern in which an agglomerated and granulated part and an unchanged part are alternately formed. It is revealed that the boundaries of both parts are sharp enough to have up to a maximum of 0.1 μm level spatial resolution. The spatial resolution of this high level can be obtained because a platinum group metal is used as material. In the case where gold or silver is used as material, the high thermal conductivity inevitably leads to an inferior spatial resolution.

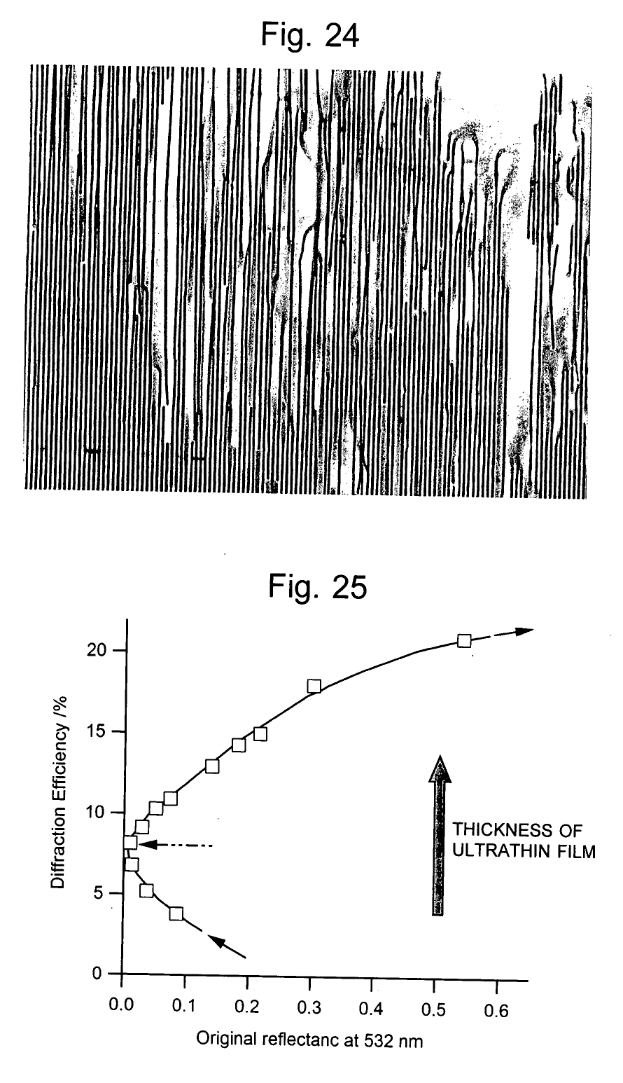

Furthermore, when the thickness of the ultrathin film is increased, the thermal diffusion in the film increases, and therefore it is not possible to obtain a favorable interference pattern. FIG. 24 shows a scanning electron microscope image obtained when pulsed laser irradiation was performed on a Pt ultrathin film having a thickness of 20 nm. The image demonstrates that the patterns are thoroughly disconnected.

In the element of the present invention including a substrate (vapor-deposited silver film), a transparent film (refractive index n=up to 1.4, thickness: approximately 90 nm) and an ultrathin platinum film, interference patterns of approximately 1000 lines/mm were recorded by irradiation of a pulsed laser of 532 nm on the ultrathin platinum film and their first-order diffraction efficiency was calculated. With regard to a plurality of elements in which the thickness of the ultrathin film was gradually changed (thickness of the ultrathin film was changed in a range approximately 2 nm to 20 nm), a graph showing the relationship between the reflectance (horizontal axis) before recording of the interference pattern and the first-order diffraction efficiency (vertical axis) after recording of the interference pattern was created, as shown in FIG. 25. The result shows that the first-order diffraction efficiency increased in association with the increase of the thickness of the ultrathin film. The first-order diffraction efficiency increased to approximately 8% in the element in which the reflectance was minimum, and kept further increasing in the region where the reflectance on the contrary increased and a reflectance prevention effect was lost, and at the maximum, the first-order diffraction efficiency exceeded 21%.

The aforementioned intensification of the first-order diffraction efficiency was presumably caused by the mutual intensification between the phase of the reflection diffraction light from the portions where the ultrathin film was present (referred to as “portion A”) and the phase of the diffraction light from the intensified electric field of the portions where the ultrathin film was practically removed (referred to as “portion B”) in the first-order diffraction direction. In order to establish such a relation, desirably the phase of complex reflection coefficient of the portions A differs from that of positions B by approximately 180°.

Therefore, by appropriately designing the thickness of the ultrathin film in the reflectance control optical element of the present invention, it becomes possible to maintain the high spatial resolution during recording of the interference pattern, as well as to obtain a high diffraction efficiency of approximately 10%. Since the diffraction efficiency is up to approximately 2% in a normal structure, it is proved that this increase of the diffraction efficiency is quite significant. With the increase of the ultrathin film thickness, it becomes gradually difficult to maintain the spatial resolution of the interference pattern, while the diffraction efficiency is further increased. In the case of creating a holographic storage media for some applications, such as a personal identification card, a diffraction grating or dispersion, it is possible to increase its diffraction efficiency as high as 20% because those applications do not require a very high resolution.

Moreover, as mentioned above, the ultrathin film light absorption enhancing element is provided with an ultrathin film having an extremely small thickness and a high light absorptivity, and therefore it is directly applicable as an efficient optical functional device, such as a solar cell.

The reflectance control optical element and applications thereof according to the present invention have been described with reference to examples; however, the applications are of course not limited to the ones previously described, and it is possible to freely add modification or changes within the idea of an element having a controllable reflectance.

1. A reflectance control optical element capable of causing a change in the reflectance of light according to a wavelength, comprising:
a substrate comprising a material having a high reflectance;
a transparent film comprising a material having a light transmissivity formed on a surface of the substrate; and
an ultrathin film having a predetermined light absorptivity formed on a surface of the transparent film, where:
the ultrathin film is a metal thin film, which is made of metal nanoparticles having an average particle diameter of 10 nm or less, the metal nanoparticles being adjacent to or in contact with each other; and
the metal is at least one member selected from the group consisting of a single platinum group element, an alloy of platinum group elements, and an alloy of a platinum group element and nickel.

2. The reflectance control optical element according to claim 1, wherein:
the ultrathin film comprises one kind of dye or a plurality of different dyes.

3. The reflectance control optical element according to claim 1, wherein:
the ultrathin film has a thickness such that a light transmittance at a given wavelength is 30 to 60%.

4. An optical storage medium using the reflectance control optical element according to claim 1.

5. An optical storage medium comprising a reflectance control optical element according to claim 1, where an unevenness is formed by changing a thickness of the transparent film.

6. An optical storage medium comprising a reflectance control optical element according to claim 1, where interference patterns are formed on the element.

7. A method of storing information comprising:
use of an optical storage medium using a reflectance control optical medium, the reflectance control optical medium including:
a substrate comprising a material having a high reflectance;
a transparent film comprising a material having a light transmissivity formed on the surface of the substrate; and
an ultrathin film, formed on the surface of the transparent film, having a predetermined light absorptivity composed of a metal thin film of at least one metal nanoparticle selected from the group consisting of a single platinum group element, an alloy of platinum group elements, and an alloy of a platinum group element and nickel, the metal nanoparticles being adjacent to or in contact with each other; and
pulsed laser irradiation on a predetermined portion of the ultrathin film for coalescence of the metal nanoparticles so that optical information is stored.

8. An ultrathin film light absorption enhancing element comprising:
a substrate having a surface made of a light scattering reflection film;
a transparent film comprising a material having a light transmissivity formed on the surface of the substrate; and
an ultrathin film having a predetermined light absorptivity formed on a surface of the transparent film.

9. The ultrathin film light absorption enhancing element according to claim 8, wherein:
the ultrathin film comprises one kind of dye or a plurality of different dyes.

10. The ultrathin film light absorption enhancing element according to claim 8, wherein:
a roughness of the surface of the transparent film is substantially the same as a roughness of the light scattering reflection film.

11. The ultrathin film light absorption enhancing element according to claim 8, wherein:
the roughness of the light scattering reflection film is equal to or less than a thickness of the transparent film.
